(19) United States
(12) Patent Application Publication
(10) Pub. No.: US 2015/0278207 A1
(43) Pub. Date: Oct. 1, 2015

(54) ELECTRONIC DEVICE AND METHOD FOR ACQUIRING IMAGE DATA

(71) Applicant: Samsung Electronics Co., Ltd., Gyeonggi-do (KR)

(72) Inventors: Jang Seok Seo, Gyeonggi-do (KR); Jong Sun Pyo, Gyeonggi-do (KR); Tae Gun Park, Gyeonggi-do (KR); Seon Hwa Han, Gyeonggi-do (KR)

(21) Appl. No.: 14/675,594

(22) Filed: Mar. 31, 2015

(30) Foreign Application Priority Data
Mar. 31, 2014 (KR) 10-2014-0037713

(51) Int. Cl. G06F 17/30; H04N 1/21; H04N 5/232

(52) U.S. Cl. CPC G06F 17/3028; H04N 5/23293; H04N 5/23229; H04N 1/2112; G06F 17/30247

(57) ABSTRACT

An electronic device includes a camera configured to acquire a preview image and image content. The electronic device also includes an image processing module configured to generate at least one attribute information through information relating to the preview image and generate image data by adding the at least one attribute information to an image content acquired from the preview image.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Mar. 31, 2014 and assigned Application No. 10-2014-0037713, the contents of which are incorporated herein by reference.

### TECHNICAL FIELD

The present disclosure relates to a device and method for acquiring image data by generating attribute information on the image data.

### BACKGROUND

In general, after an electronic device performing a camera function captures image data, a user can enter a gallery storing the image data and classify the image data by setting a folder to which the image data is moved. Additionally, after image data is acquired, a user can enter a gallery to check the image data and then can enter a menu to acquire the image data again.

The above typical electronic device can enter a gallery storing image data to select at least one image data and then can move the selected at least one image data to a specific folder to classify the image data, which can be inconvenient.

Additionally, the typical electronic device can acquire image data and enter a gallery to check the acquired image data and then can enter a menu to acquire the image data again. This can also be inconvenient.

### SUMMARY

To address the above-discussed deficiencies, it is a primary object to provide an electronic device and method for generating attribute information for image data classification before acquiring image data and then assigning the attribute information to the acquired image data so as to acquire storable image data.

In a first example, an electronic device can implement a method for outputting a preview image to an image file list for checking stored image data and acquiring image data from the image file list.

In a second example, an electronic device can implement a method for assigning attribute information set in at least one image data configuring an image file list to image data acquired from the image file list.

In a third example, an electronic device includes a camera configured to acquire a preview image and image content. The electronic device also includes an image processing module configured to generate at least one piece of attribute information through information relating to the preview image and generate image data by adding the at least one piece of attribute information to an image content acquired from the preview image.

In a fourth example, a method of acquiring image data includes entering an image data acquisition mode. The method also includes acquiring a preview image and checking information relating to the preview image. The method further includes generating at least one piece of attribute information through the information relating to the preview image. The method includes generating image data by adding the at least one piece of attribute information to an image content acquired from the preview image.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example block diagram illustrating a main configuration of an electronic device for acquiring image data according to this disclosure.

FIG. 2 is an example flowchart illustrating a method of acquiring image data according to this disclosure.

FIGS. 3A through 3C are example screen views illustrating a method for setting attribute information in a preview image according to this disclosure.

FIGS. 4A through 4C are example flowcharts illustrating a method of acquiring new image data from an image file list according to this disclosure.

FIGS. 5A and 5B are example screen views illustrating a method for setting the size of a preview image displayed on an image file list according to this disclosure.

FIGS. 6A through 6E are example screen views illustrating a method of aligning image data by using attribute information according to this disclosure.

FIGS. 7A through 7D are example screen views illustrating a method for changing attribute information on image data selected from image data according to this disclosure.

FIG. 8 is an example block diagram illustrating an electronic device according to this disclosure.

### DETAILED DESCRIPTION

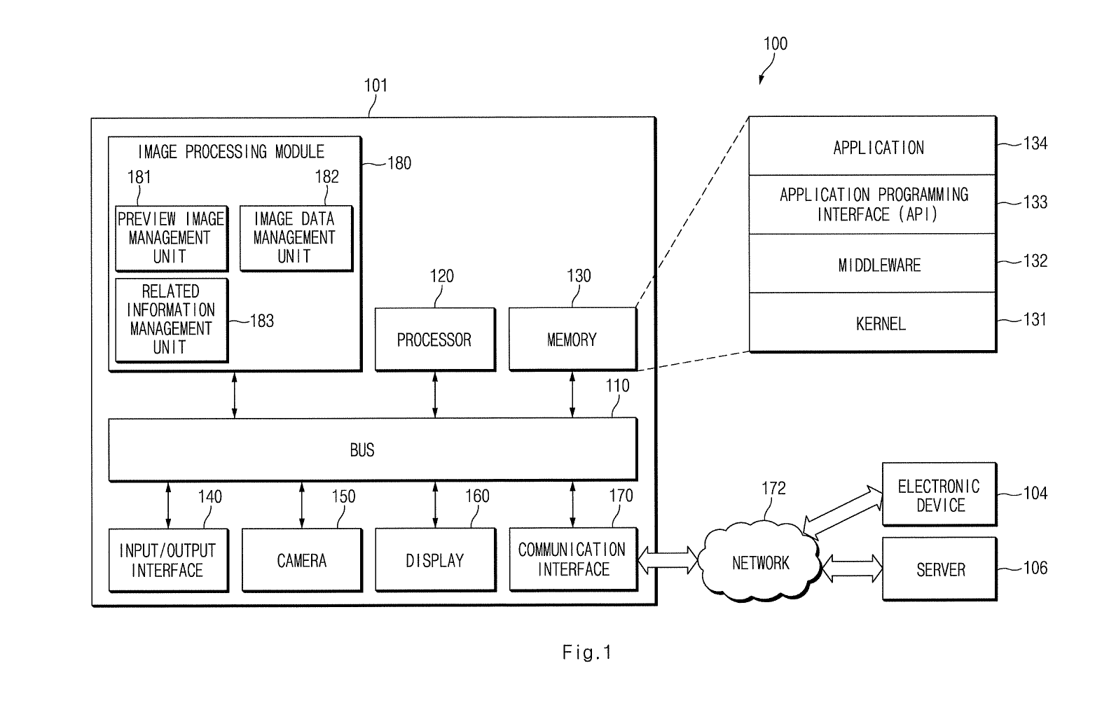

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, embodiments disclosed herein will be described in more detail with reference to the accompanying drawings. Various embodiments disclosed herein are shown in the drawings and related details are described, but various modifications are possible and more embodiments can be introduced. Thus, it is intended that the present disclosure covers the modifications and variations of this disclosure provided they come within the scope of the appended claims and their equivalents. With respect to the descriptions of the drawings, like reference numerals refer to like elements.

The term “include,” “comprise,” “including,” or “comprising,” specifies a property, a region, a fixed number, a step, a process, an element and/or a component but does not exclude other properties, regions, fixed numbers, steps, processes, elements and/or components. The meaning of “include,” “comprise,” “including,” or “comprising,” specifies a property, a region, a fixed number, a step, a process, an element and/or a component but does not exclude other properties, regions, fixed numbers, steps, processes, elements and/or components.

In this specification, the expression “or” includes any or all combinations of words listed. For example, “A or B” can include A or include B or include both A and B.

The terms ‘first’ and/or ‘second’ can be used to describe various elements. However, the elements should not be limited by these terms. For example, the above expressions do not limit the order and/or importance of corresponding components. The expressions can be used to distinguish one component from another component. For example, a first user device and a second user device can be all user devices and represent different user devices. For example, a first component can be referred to as a second component and vice versa without departing from the scope of the present invention.

In this disclosure below, when one part (or element, device, etc.) can be referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it can mean that no intervening component is present.

Terms used in this specification can be used to describe specific embodiments, and may not be intended to limit the scope of the present disclosure. The terms of a singular form can include plural forms unless they have a clearly different meaning in the context.

Otherwise indicated herein, all the terms used herein, which include technical or scientific terms, can have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning.

An electronic device according to this disclosure can be a device having a camera function. For example, an electronic device can include at least one of smartphones, tablet personal computers (PCs), mobile phones, video phones, e-book readers, desktop PCs, laptop PCs, netbook computers, personal digital assistants (PDAs), portable multimedia players (PMPs), MP3 players, mobile medical equipment, cameras, or wearable devices (for example, head-mounted-devices (HMDs) such as electronic glasses, electronic clothing, electronic bracelets, electronic necklaces, appcessories, electronic tattoos, or smartwatches).

In an embodiment, electronic devices can be smart home appliance having a camera function. Smart home appliance, for example, an electronic device, can include at least one of digital video disk (DVD) players, audio systems, refrigerators, air conditioners, vacuum cleaners, ovens, microwaves, washing machines, air purifiers, set-top boxes, TV boxes (for example, the Samsung HomeSync™, Apple TV™, or Google TV™), game consoles, electronic dictionaries, electronic key, camcorders, or electronic frames.

An electronic device can include at least one of various medical devices (for example, magnetic resonance angiography (MRA) devices, magnetic resonance imaging (MRI) devices, computed tomography (CT) devices, medical imaging devices, ultrasonic devices, etc.), navigation devices, global positioning system (GPS) receivers, event data recorders (EDRs), flight data recorders (FDRs), vehicle infotainment devices, marine electronic equipment (for example, marine navigation systems, gyro compasses, etc.), avionics, security equipment, car head units, industrial or household robots, financial institutions' automated teller machines (ATMs), and stores' point of sales (POS).

In an embodiment, an electronic device can include at least one of furniture or buildings/structures having a camera function, electronic boards, electronic signature receiving devices, projectors, or various measuring instruments (for example, water, electricity, gas, or radio signal measuring instruments). An electronic device can be one of the above-mentioned various devices or a combination thereof. Additionally, an electronic device can be a flexible device. Furthermore, it is apparent to those skilled in the art that an electronic device may not be limited to the above-mentioned devices.

Hereinafter, embodiments will be described in more detail with reference to the accompanying drawings. The term “user” in various embodiments can refer to a person using an electronic device or a device using an electronic device (for example, an artificial intelligent electronic device).

FIG. 1 is an example block diagram illustrating a main configuration of an electronic device for acquiring image data according to this disclosure. Referring to FIG. 1, the electronic device 101 in a network environment 100 can include a bus 110, a processor 120, a memory 130, an input/output interface 140, a camera 150, a display 160, a communication interface 170, and an image processing module 180. The image processing module 180 can include a preview image management unit 181, an image data management unit 182, and a related information management unit 183. The electronic device 101 can acquire a preview image and information (hereinafter referred to as related information) relating to the acquired preview image. The electronic device 101 can generate at least one piece of attribute information according to checked related information and can generate image data by adding the attribute information to an image content corresponding to a preview image. At this point, the preview image can mean an image where a frame acquired in real time through the camera 150 is outputted. The related information can include an entry path to an image data acquisition mode, an attribute information setting of a pre-stored image file, and attribute information set in a pre-stored image file. The attribute information can be information that a user sets for image content or a specific object in image content, for example, tag information.

The bus 100 can be a circuit connecting the above-mentioned components to each other and delivering a communication (for example, a control message) therebetween.

The processor 120 can receive an instruction from the above other components (for example, the memory 130, the input/output interface 140, the camera 150, the display 160, the communication interface 170, or the image processing module 180) through the bus 110, interpret the received instruction, and perform operations and data processing in response to the interpreted instruction.

The memory 130 can store an instruction or data received from the processor 120 or other components (for example, the input/output interface 140, the camera 150, the display 160, the communication interface 170, or the image processing module 180) or an instruction or data generated from the processor 120 or other components. The memory 130 can include programming modules, for example, a kernel 131, a middleware 132, an application programming interface (API) 133, or an application 134. Each of the above-mentioned programming modules can be configured with software, firmware, hardware, or a combination thereof. The memory 130 can store a feature point analysis algorithm for extracting and analyzing at least one feature point from an object in a preview screen. The memory 130 can temporarily store a preview image acquired from the camera 150. The memory 130 can store at least one image file. The memory 130 can store at least one piece of attribute information, folder information, and information on a save path of image content. At this point, the attribute information and the folder information can be set in the electronic device 101 by default and modification and additional setting can be possible by a user.

The kernel 131 can control or manage system resources (for example, the bus 110, the processor 120, or the memory 130) used for performing operations or functions implemented by the remaining other programming modules, for example, the middleware 132, the API 133, or the application 134. Additionally, the kernel 131 can provide an interface for accessing an individual component of the electronic device 101 from the middleware 132, the API 133, or the application 134 and controlling or managing it.

The middleware 132 can serve as an intermediary role for exchanging data between the API 133 or the application 134 and the kernel 131 through communication. Additionally, in relation to job requests received from the application 134, the middleware 132 can perform a control for a job request (for example, scheduling or load balancing) by using a method of assigning a priority for using a system resource (for example, the bus 110, the processor 120, or the memory 130) of the electronic device 101 to at least one application 134 among applications 134.

The API 133, as an interface through which the application 134 controls a function provided from the kernel 131 or the middleware 132, can include at least one interface or function (for example, an instruction) for file control, window control, image processing, or character control.

The input/output interface 140 can deliver an instruction or data inputted from a user through an input/output device (for example, a sensor, a keyboard, or a touch screen) to the processor 120, the memory 130, the camera 150, the communication interface 170, or the image processing module 180 through the bus 110. For example, the input/output interface 140 can provide data for a user's touch inputted through a touch screen to the processor 120. Additionally, the input/output interface 140 can output an instruction or data inputted from a user through the processor 120, the memory 130, the camera 150, the communication interface 170, or the image processing module 180 through the bus 110, to an input/output device (for example, a speaker or a display).

The camera 150 can acquire a preview image according to a control of the image processing module 180. The camera 150 can provide image content acquired from a preview image to the image processing module 180. For this, the camera 150 can include at least one image sensor (for example, a front sensor or a rear sensor), a lens, an image signal processor (ISP), or a flash LED (for example, an LED or a xenon lamp).

The display 160 can provide various information (for example, multimedia data or text data) to a user. For example, the display 160 can display various screens operating according to a control of the image processing module 180. The display 160 can output a preview image acquired from the camera 150 and can output an image file list for all pre-stored image files according to a control of the image processing module 180. The display 160 can output an image file list aligned based on attribute information or folder information according to a control of the image processing module 180. The display 160 can output a preview image on an image file list.

The communication interface 170 can connect a communication between the electronic device 101 and external devices (for example, an electronic device 104 or a server 106). For example, the communication interface 170 can be connected to a network 172 through wired or wireless communication to communicate with an external device. The wired communication, for example, can include at least one of Universal Serial Bus (USB), High Definition Multimedia Interface (HDMI), Recommended Standards 232 (RS-232), or Plain Old Telephone Service (POTS). The wireless communication, for example, can include at least one of Wireless Fidelity (Wi-Fi), Bluetooth (BT), Near Field Communication (NFC), or a cellular communication (for example: LTE, LTE-A, CDMA, WCDMA, UMTS, WiBro, or GSM).

In an embodiment, the network 172 can be a telecommunications network. The telecommunications network can include at least one of a computer network, internet, internet of things, or telephone network. According to an embodiment of the present invention, a protocol (for example, a transport layer protocol, a data link layer protocol, and a physical layer protocol) for communication between the electronic device 101 and an external device can be supported by at least one of the application 134, the application programming interface 133, the middleware 132, the kernel 132, or the communication interface 170.

The communication interface 170 can receive at least one image content or image data from an external device through wired or wireless communication and can then provide it to the image processing module 150. At this point, image content can mean content having no set attribute information and image data can mean data having attribute information set in image content.

The image processing module 180 can process at least part of information acquired from other components (for example, the processor 120, the memory 130, the input/output interface 140, the camera 150, or the communication interface 170) and can then provide it to a user through various methods. For example, the image processing module 180 can control at least some functions of the electronic device 101 to allow the electronic device 101 to link with an external device by using the processor 120 or being separated from the processor 120. The image processing module 180 can generate at least one piece of attribute information by checking related information relating to a preview image acquired from the camera 150. The image processing module 180 can acquire a preview screen as image content according to an image data acquire signal and can then generate image data by adding generated attribute information to image content. The image processing module 180 can store the generated image data according to attribute information.

In an embodiment, when a signal for checking a pre-stored image file is received from the input/output interface 140, the image data management unit 182 can output an image file list for all image files pre-stored in the memory 130 to the display 160. While the image file list is displayed on the display 160, upon the receipt of an acquisition mode enter signal for acquiring image data from the input/output interface 140, the preview image management unit 181 can activate the camera 150.

The preview image management unit 181 can output a preview image acquired from the camera 150 to a partial area of the image file list. When an acquire signal for acquiring a preview image as image content is received from the input/output interface 140, the image data management unit 182 can acquire a preview image as image content. The image data management unit 182 can store the acquired image content in the image data 152.

Since the image data management unit 182 can generate image content from an image file list for all pre-stored image files, it can store the generated image content in an entire image file list without a specific save path. While a save path of image content is stored in the related information 153, the image data management unit 182 can store image content in a list corresponding to a corresponding save path. While a save path of image content is not stored in the related information 153, the image data management unit 182 can store image content in a list corresponding to a save path inputted from the input/output interface 140. When the related information management unit 183 receives at least one piece of attribute information on image content from the input/output interface 140, the image data management unit 182 can generate image data by adding attribute information to image content. The image data management unit 182 can store the generated image data in a list corresponding to the attribute information. The attribute information can be inputted before a preview image is outputted, inputted when a preview image is outputted, or inputted after image content is acquired.

In an embodiment, when a signal for checking a pre-stored image file is received from the input/output interface 140, the image data management unit 182 can output an image file list for entire image files pre-stored in the memory 130 to the display 160. The image data management unit 182 can receive at least one attribute information or folder information for aligning an image file from the input/output interface 140. When information for alignment is received from the input/output interface 140, the image data management unit 182 can extract an image file corresponding to the information from a pre-stored image file and can then output an image file list to the display 160. While the image file list is displayed on the display 160, upon the receipt of an acquisition mode enter signal for acquiring image data from the input/output interface 140, the preview image management unit 181 can activate the camera 150.

The preview image management unit 181 can output a preview image acquired from the camera 150 to a partial area of the image file list. While an image file is aligned by folder information, upon the receipt of an acquire signal for image acquisition from the input/output interface 140, the image data management unit 182 can acquire a preview image as image content. The image data management unit 182 can store image content in a list corresponding to folder information. When the related information management unit 183 receives at least one attribute information on image content from the input/output interface 140, the image data management unit 182 can generate image data by adding attribute information to image content. The image data management unit 182 can store the generated image data in a list corresponding to the attribute information and a list corresponding to the folder information.

When an image file is aligned by attribute information inputted from the input/output interface 140, the image data management unit 182 can generate the inputted attribute information as attribute information on a preview image. While an acquire signal for image acquisition is received from the input/output interface 140, the image data management unit 182 can acquire a preview image as image content. The image data management unit 182 can generate image data by adding the generated attribute information to image content. The image data management unit 182 can store the generated image data as an image file in the image data 152. The image data management unit 182 can store the generated image data in a list corresponding to the attribute information.

When an image file is aligned by attribute information and folder information inputted from the input/output interface 140, the image data management unit 182 can generate the inputted attribute information as attribute information on a preview image. While an acquire signal for image acquisition is received from the input/output interface 140, the image data management unit 182 can acquire a preview image as image content. The image data management unit 182 can generate image data by adding the generated attribute information to image content. The image data management unit 182 can store the generated image data as an image file in the image data 152. The image data management unit 182 can store the generated image data in a list corresponding to the attribute information and the folder information.

In an embodiment, while a screen such as an idle screen or an execution screen of the application 134 is outputted on the display 160, upon the receipt of an input signal for at least one of shortcut keys, shortcuts, menus, and icons from the input/output interface 140, the preview image management unit 181 can activate the camera 150. The preview image management unit 181 can output a preview image acquired from the camera 150 to the display 160.

The preview image management unit 181 can analyze a preview image. At this point, the preview image management unit 181 can capture a preview image and can then temporarily store it in a buffer 151 in order to analyze the preview image. The preview image management unit 181 can extract an image file having a feature similar to that of a preview image by more than a critical value from at least one pre-stored image file by analyzing the preview image. When an object in a preview is a person, the preview image management unit 181 can extract an image file including an object having a at least one feature point similar to that by more than a critical value from at least one pre-stored image file by checking the feature point of the object. At this point, the object can be selected by the input/output interface 140.

Once the image file is extracted, the related information management unit 183 can check attribute information set in the image file, for example, tag information. The related information management unit 183 can generate attribute information on a preview image by using the checked attribute information. When an acquire signal for image acquisition is received from the input/output interface 140, the image data management unit 182 can acquire a preview image as image content. The image data management unit 182 can generate image data by adding attribute information generated from the related information management unit 183 to image content. If attribute information is not set in an image file, the related information management unit 183 can receive the attribute information from the input/output interface 140.

The image data management unit 182 can generate image data by adding the inputted attribute information to image content. The image data management unit 182 can store the generated image data in the image data 152. The image data management unit 182 can store image data in a list corresponding to attribute information.

In an embodiment, the electronic device 101 acquiring image data can include the camera 150 for acquiring a preview image and image content and the image processing module 180 for generating at least one attribute information through information relating to the preview image and generating image data by adding the at least one attribute information to an image content acquired from the preview image.

The image processing module 180 can check information relating to the preview image by checking an entry path to an image data acquisition mode for generating the image data. The image processing module 180 can extract an image file list by aligning at least one pre-stored image file on the basis of attribute information or folder information. When entering the image data acquisition mode from an image file list, the image processing module 180 can output the preview image on the image file list through the display 160.

When a signal for performing at least one of the size adjustment and movement of the preview image is received through the input/output interface 140, the image processing module 180 can perform at least one of the size adjustment and movement of the preview image according to the signal. The image processing module 180 can generate attribute information on the image content by using the attribute information set in at least one image file configuring the image file list. When entering the image data acquisition mode through at least one of shortcut keys, shortcuts, menus, and icons, the image processing module 180 can generate attribute information set in an image file having a feature similar to that of the preview image by more than a critical value among at least one pre-stored image file by using the attribute information on the image content after analyzing the preview image.

When a select signal for at least one object in the preview image is received from the input/output interface 140, the image processing module 180 can check at least one feature point of an object corresponding to the select signal. The image processing module 180 can stores the generated image data on the basis of the attribute information added to the generated image data or the entry path.

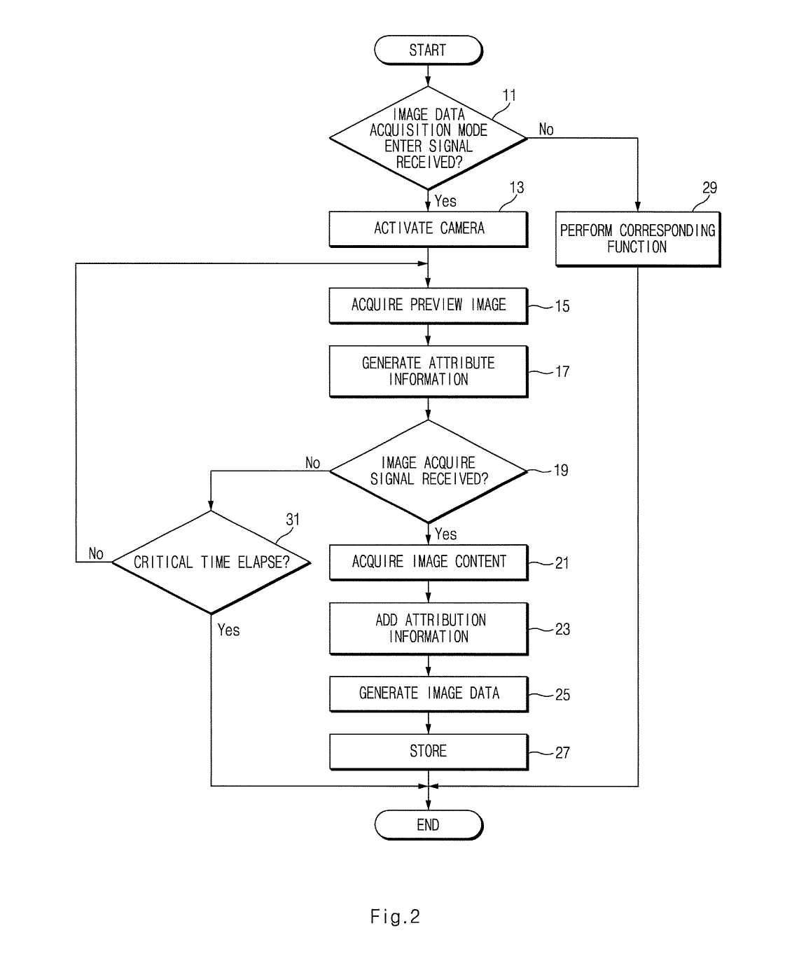

FIG. 2 is an example flowchart illustrating a method of acquiring image data according to this disclosure.

Referring to FIGS. 1 and 2, in operation 11, the image processing module 180 can check whether an acquisition mode enter signal for acquiring image is received from the input/output interface 140. When the acquisition mode enter signal is received in operation 11, the image processing module 180 can perform operation 13. When the acquisition mode enter signal is not received in operation 11, the image processing module 180 can perform operation 29. In operation 29, the image processing module 180 can output an idle screen continuously or can perform a function being performed continuously. At this point, the acquisition mode enter signal can be generated from an input occurring while an image file list for checking a pre-stored image file is outputted to the display 160 or can be generated from an input from at least one of shortcut keys, shortcuts, menus, and icons while a screen such as a standby screen and an execution screen of the application 134 is outputted to the display 160.

In operation 13, the image processing module 180 can activate the camera module 150. In operation 15, the image processing module 180 can output a preview image acquired from the camera 150 to the display 160. The preview image can be an image where a frame acquired in real time through the camera 150 is outputted.

In operation 17, the image processing module 180 can check related information relating to a preview image and can then generate at least one attribute information on the preview image according to the checked related information. At this point, the related information can include an entry path to an image data acquisition mode, attribute information setting of a pre-stored image file, and attribute information set in a pre-stored image file. The attribute information can be information that a user sets for image content or a specific object in image content, for example, tag information. In an embodiment, the image processing module 180 can check the entry path to an image data acquisition mode. The entry path can be a path through a list for checking all pre-stored image files, a path through a list for checking an image file on the basis of folder information set in a pre-stored image file, and a path through a list for checking an image file on the basis of attribute information set in an image file. When entering the image data acquisition mode from an image file list according to the entry path, the image processing module 180 can output a preview image on part of the image file list.

When the entry path is a path through a list for checking all pre-stored image files or a path through a list for checking an image file on the basis of folder information, the image processing module 180 can generate attribute information on a preview image by using attribute information received from the input/output interface 140. For example, the image processing module 180 can output the preview image on the display 160 and can output a user interface for generating attribute information on the preview image. The image processing module 180 can generate the attribute information by using information inputted to the user interface by a user through the input/output interface 140.

If the entry path is a path through a list for checking an image file on the basis of attribute information, the image processing module 180 can check attribute information set in an image file. The image processing module 180 can generate attribute information on a preview image by using the checked attribute information. For example, if the attribute information is “travel”, the image processing module 180 can automatically generate attribute information on a preview image as “travel”.

In an embodiment, the image processing module 180 can check an entry path to an image data acquisition mode. When entering the image data acquisition mode from an image file list according to the entry path, the image processing module 180 can output a preview image on part of the image file list. The image processing module 180 can extract an image file having a feature similar to that of a preview image by more than a critical value from at least one pre-stored image file by analyzing the preview image. The image processing module 180 can generate the attribute information set in the extracted image file as attribute information on a preview image. For example, if the preview image relates to “sea”, the image processing module 180 can extract at least one image file having a structure similar to that of the preview image from pre-stored image files. If the attribute information set in the extracted image is “nature” or “travel”, the image processing module 180 can automatically generate the attribute information on a preview as “nature” or “travel”.

When a select signal for at least one object in the preview image is received from the input/output interface 140, the image processing module 180 can check the feature point of the object. The image processing module 180 can extract an object having a feature point similar to the feature point by more than a critical value from at least one pre-stored image file. The image processing module 180 can generate the attribute information set in the extracted object or the attribute information set in an image file having the object as attribute information on a preview image. For example, when a selected object in a preview image is a person, the image processing module 180 can check a first feature point from the object, for example, the positions of the eyes, nose, and mouth. The image processing module 180 can extract an object having a second feature point similar to the checked first feature point by more than a critical value from pre-stored image files. The image processing module 180 can check the attribute information set in the object having the second feature point or the attribute information set in the image file having the object with the second feature point. The image processing module 180 can generate the attribute information on a preview image by using the checked attribute information.

In operation 19, the image processing module 180 can check whether an acquire signal for image acquisition is received from the input/output interface 140. At this point, the acquire signal can be an acquire signal received through the input/output interface 140 or the display 160 or an acquire signal set by a predetermined timer. When an acquire signal is received in operation 19, the image processing module 180 can perform operation 21 and when the acquire signal is not received in operation 19, the image processing module 180 can perform operation 31. If it is checked that the acquire signal for an image is not received for more than a critical time in operation 31, the image processing module 180 can terminate an acquisition mode. If the image acquire signal for an image is not received for less than a critical time in operation 31, the image processing module 180 can return to operation 15 and can then perform the above operations again. If a movement occurs in the camera 150 and thus a preview image is changed before an image acquire signal is received, the image processing module 180 can output the changed preview image to the display 160. The image processing module 180 can check related information relating to the changed preview image and can then generate at least one attribute information in the preview image according to the checked related information.

In operation 21, when an acquire signal is received by controlling the camera 150, the image processing module 180 can acquire a frame corresponding to a preview image outputted to the display 160 as image content. In operation 23, the image processing module 180 can add the attribution information generated in operation 17 to the acquired image content. The image processing module 180 can generate the image content having the attribution information added thereto as image data in operation 25, and can store the generated image data in operation 27. The image processing module 180 can store the generated image data according to attribute information. When image content is acquired from an image file list aligned on the basis of folder information, the image processing module 180 can store the image data in a list corresponding to the attribute information and the folder information. In an embodiment, after storing the image data, the image data acquisition mode can be terminated, but the present invention is not limited thereto. For example, after storing the image data, when a signal for terminating the image data acquisition mode is received from a user through the input/output interface 140, the image processing module 180 can terminate the image data acquisition mode. When the signal for terminating the image data acquisition mode is not received from a user, the image processing module 180 can return to operation 15 and can then perform the above operations again.

In an embodiment, a method for acquiring image data can include entering an image data acquisition mode, acquiring a preview image, checking information relating to the preview image, generating at least one attribute information through the information relating to the preview image, and generating image data by adding the at least one attribute information to an image content acquired from the preview image.

The checking of the information relating to the preview image can be an operation for checking the information relating to the preview image by checking an entry path to the image data acquisition mode for generating the image data.

The generating of the at least one attribute information can further include an operation for extracting an image list by aligning at least one pre-stored image file on the basis of attribute information and folder information and an operation for outputting the preview image on the image file list, and can be an operation for generating attribute information on the image content by using attribute information set in at least one image file configuring the image file list.

The generating of the at least one attribute information can be an operation, when entering the image data acquisition mode through at least one of shortcut keys, shortcuts, menus, and icons, for generating attribute information set in an image file having a feature similar to the feature of the preview image by more than a critical value among at least one pre-stored image file as attribute information on the image content by analyzing the preview image.

The generating of the at least one attribute information can further include an operation for receiving a select signal for at least one object from the preview image and an operation for checking a at least one feature point for an object corresponding to the select signal, and can be an operation for generating attribute information set in an image file having a feature point similar to the at least one feature point of the preview image by more than a critical value among the at least one pre-stored image file as attribute information on the image content.

The generating of the at least one attribute information can further include an operation for storing the generated image data on the basis of the at least one attribute information added to the generated image data or the entry path.

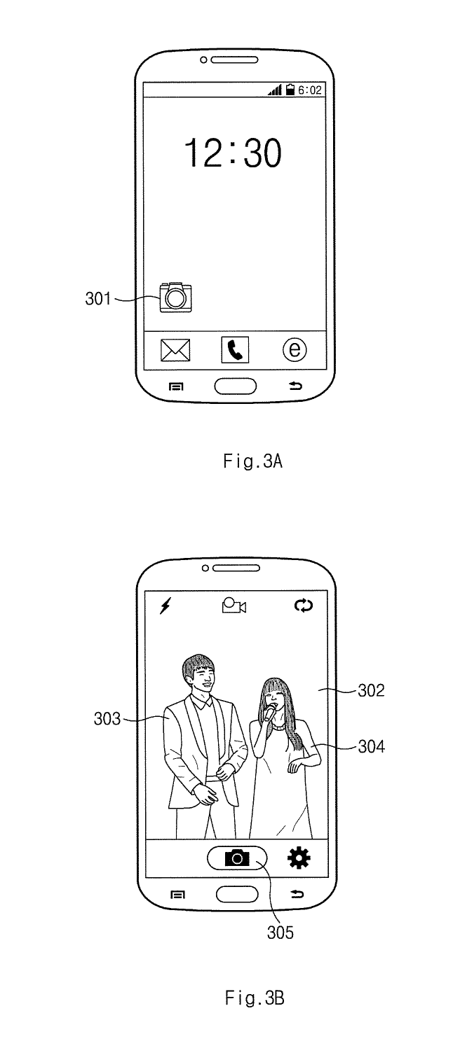

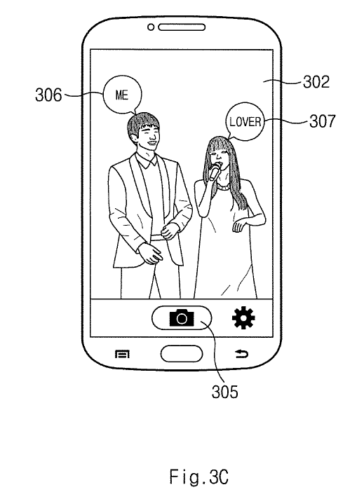

FIGS. 3A through 3C are example screen views illustrating a method for setting attribute information in a preview image according to this disclosure.

Referring to FIG. 1 and FIGS. 3A through 3C, when a user selects an icon 301 to enter an image data acquisition mode from an idle screen as shown in FIG. 3A, the electronic device 101 can display a preview image 302 acquired from the camera 150 on the display 160 as shown in FIG. 3B. If objects 303 and 304 in the preview image 302 are identified as persons by analyzing the preview image 302, the electronic device 101 can check a first feature point of the objects 303 and 304. The electronic device 101 can check the first feature point, for example, the positions of the eyes, noises, and mouths of the objects 303 and 304. The electronic device 101 can extract an image file including an object with a second feature point similar to the checked first feature point by more than a critical value from pre-stored image files. The electronic device 101 can check the attribute information set in the object having the second feature point or the attribute information set in the image file having the object with the second feature point. The electronic device 101 can automatically generate the attribute information on a preview image by using the checked attribute information.

The electronic device 101 can display the generated attribute information as “me” 306 or “lover” 307 as shown in FIG. 3C. At this point, when a signal for generating at least one of attribute information on “me” 306 or “lover” 307 again displayed on the preview image is received through the input/output interface 140, the electronic device 101 can receive attribute information through the input/output interface 140 or can generate attribute information again through a feature analysis. While the attribute information is displayed on the preview image as shown in FIG. 3C, on the receipt of a signal (an input signal for an area 305) for acquiring an image through the input/output interface 140, the electronic device 101 can acquire the preview image as image content. The electronic device 101 can add attribute information to the acquired image content and can then generate and store image data. The electronic device 101 can store the generated image data in a list corresponding to the attribute information. At this point, in an embodiment, one attribute information can be set in one object but the present invention is not limited thereto. That is, a plurality of attribute information can be set in one object.

Additionally, according to the embodiments of FIGS. 3A through 3C, the electronic device 101 can identify an object from a preview image by analyzing the preview image but the present invention is not limited thereto. That is, the electronic device 101 can receive a select signal for objects 303 and 304 in the preview image 302 from a user.

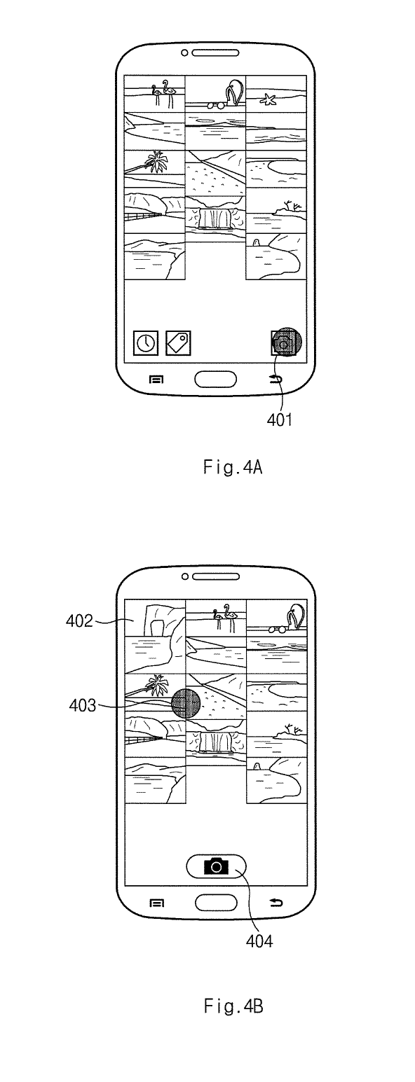

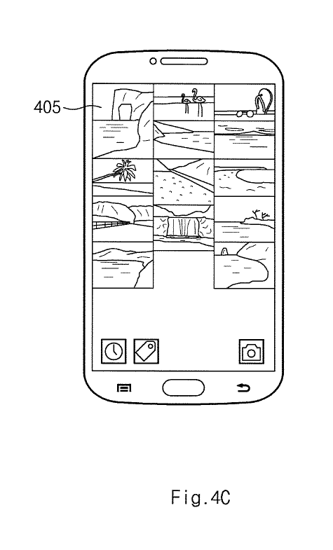

FIGS. 4A through 4C are example flowchart illustrating a method of acquiring new image data from an image file list according to this disclosure.

Referring to FIG. 1 and FIGS. 4A through 4C, when a signal for checking a pre-stored image file by using specific attribute information is received from a user, the electronic device 101 can extract an image file having set specific attribute information from the pre-stored image. As shown in FIG. 4A, the extracted image file can be outputted to the display 160. For example, when a user inputs specific attribute information as “nature” and “travel”, the electronic device 101 can extract an image file in which the specific attribute information is set with two, that is, both “travel” and “nature”, from pre-stored image files, and can then output it as shown in FIG. 4A. At this point if the specific attribute information is inputted as “travel”, “nature”, and “me”, the electronic device 101 can extract an image file in which the attribute information is set with three, that is, “travel”, “nature”, and “me”, from pre-stored image files.

If an icon 401 is selected as shown in FIG. 4B, the electronic device 101 can output a screen shown. When an acquire signal for acquiring image data is received in FIG. 4A, the electronic device 101 can output a preview image to a predetermined area 402 of an image file list as shown in FIG. 4B. Since the image file list is aligned with image files having two attributes such as “travel” and “nature”, the electronic device 101 can generate attribute information on a preview image displayed on a predetermined area 402 of the image file list as “travel” and “nature”.

When an image data acquire signal is received from the image file list outputted on the preview image, for example, an arbitrary portion 403 of the display 160 is touched or an icon 404 is selected, the electronic device 101 can acquire a preview image as image content. The electronic device 101 can generate image data by adding “nature” and “travel” as attribute information to the obtained image content and can then store the generated image data in an image file list 405 having set specific attribute information. In an embodiment, image data can be generated from an image file list having set specific attribute information but the present invention is not limited thereto. That is, image data can be generated from an image file list aligned based on folder information and also image data can be generated from an image file list aligned based on specific attribute information and folder information. Image data generated from an image file list aligned based on folder information can be stored in a list corresponding to the folder information or image data generated from an image file list aligned based on specific attribute can be stored in a list corresponding to the attribute information and the folder information. At this point, the image data can be respectively stored in a list corresponding attribute information and a list corresponding to folder information or can be stored in a list corresponding to both attribute information and folder information.

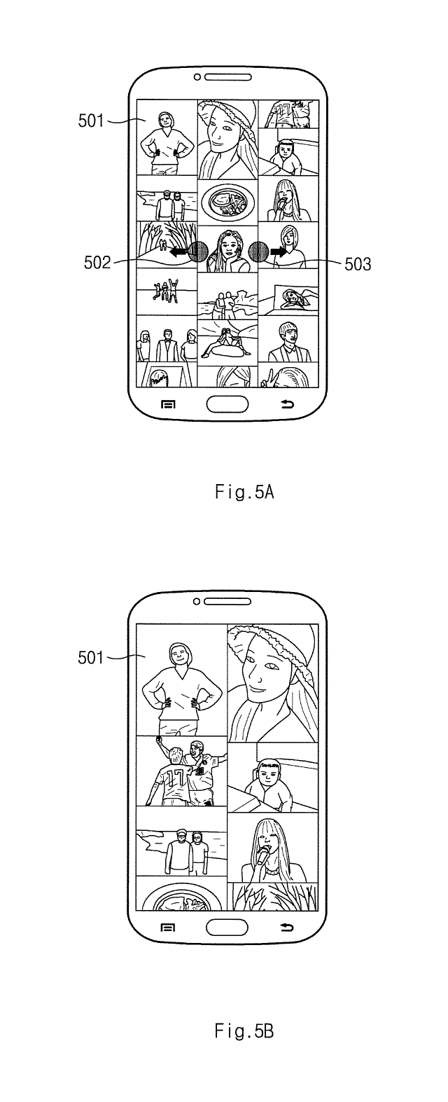

FIGS. 5A and 5B are example screen views illustrating a method for setting the size of a preview image displayed on an image file list according this disclosure.

Referring to FIG. 1 and FIGS. 5A and 5B, when entering an image data acquisition mode from an image file list, the electronic device 101 can output a screen to the display 160. A preview image 501 can be outputted to an image file list as shown in FIG. 5A. When a user touches and drags arbitrary portions 502 and 503 of the display 160 as shown in the screen of FIG. 5A, the electronic device 101 can enlarge or reduce the size of the preview image 501. When a user touches the preview image 501 for a critical time in the screen as shown in FIG. 5A and then drags the touch, the preview image 501 can move to the position where the drag ends. While the image file list is outputted, if a user touches an arbitrary portion of the display 160 and drags it as shown in an area 503 of FIG. 5A, the electronic device 101 can enlarge and output the size of the preview image 501 of FIG. 5B.

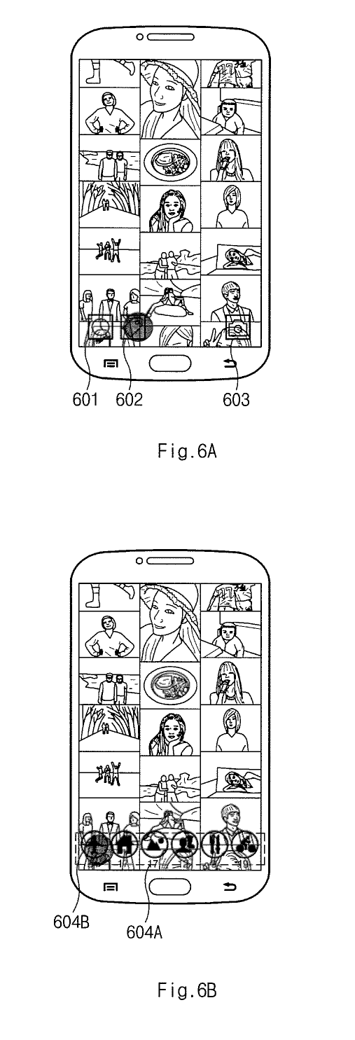

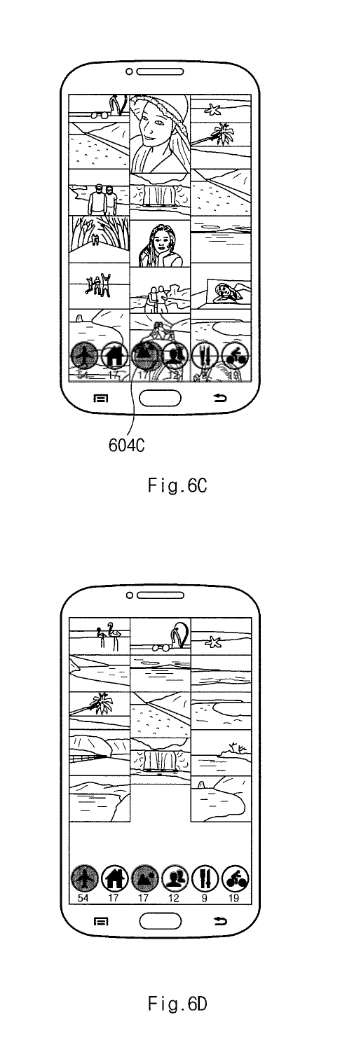

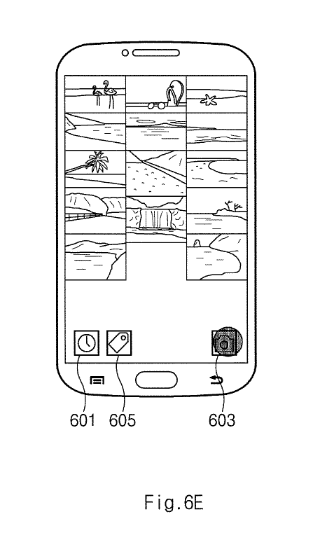

FIGS. 6A through 6E are screen views illustrating a method of aligning image data by using attribute information according to this disclosure.

Referring to FIG. 1 and FIGS. 6A through 6E, when entering a menu to check a pre-stored image file, the electronic device 101 can output at least one pre-stored image file to the display 160 as shown in FIG. 6A. When a select signal for an area 601 is received from a user as shown in FIG. 6A, the electronic device 101 can align image files according to the chronological order at which at least one outputted image file is stored and can then output the aligned image files. When a select signal for an area 603 is received from a user as shown in FIG. 6A, the electronic device 101 can add a preview image to a list including an outputted image file.

When a select signal for an area 602 is received from a user as shown in FIG. 6A, the electronic device 101 can output the types of attribute information set in at least one outputted image file as shown in an area 604A of FIG. 6B. The area 604A can include icons respectively representing attribute information such as travel, home, nature, friends, food, and outdoor. The number of image files having corresponding set attribute information can be displayed at the bottom of each of the icons in the area 604A.

When an icon 604B corresponding to “travel” is selected from FIG. 6B, the electronic device 101 can extract an image file having attribute information set as “travel” among image files shown in FIG. 6A and can then output an image file list as shown in FIG. 6C. When an icon 604C corresponding to “nature” is selected from FIG. 6C, the electronic device 101 can extract an image file having attribute information set as “nature” among image files shown in FIG. 6C and can then output an image file list as shown in FIG. 6D. In such a manner, the electronic device 101 can generate an image file list corresponding to attribute information by using at least one attribute information. The color of an icon corresponding to attribute information selected for generating an image file list can vary as shown in the icons 604B and 604C of FIG. 6D. When an image file list is generated completely, the electronic device 101 can output a screen as shown in FIG. 6E. When a select signal for an area 605 is received as shown in FIG. 6E, the electronic device 101 can change attribute information set in at least one image file selected from an aligned image file list as shown in FIG. 6E.

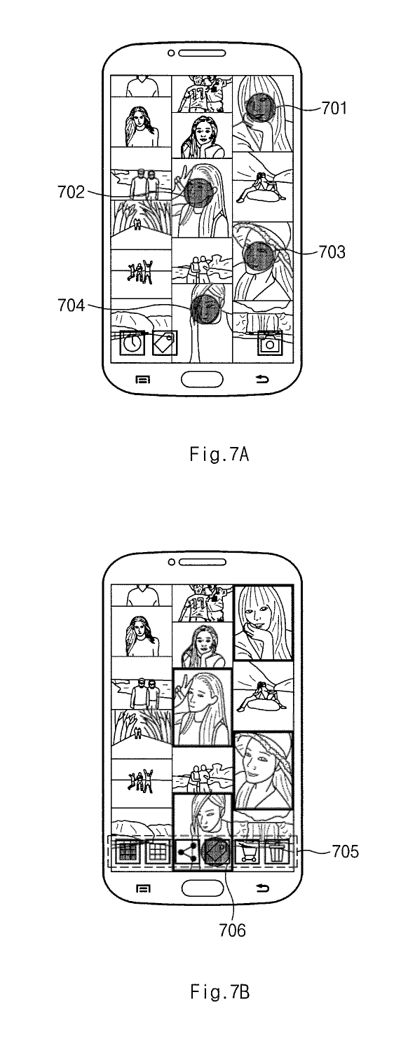

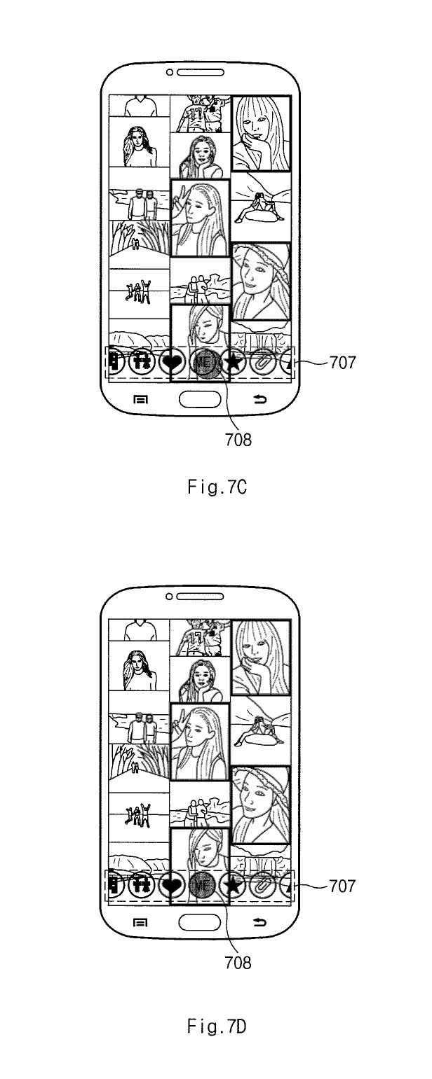

FIGS. 7A through 7D are screen views illustrating a method for changing attribute information on image data selected from image data according to this disclosure.

Referring to FIG. 1 and FIGS. 7A through 7D, when the electronic device 101 enters a menu to check a pre-stored image file, the display 160 of the electronic device 101 can output an image file list for at least one pre-stored image file as shown in FIG. 7A. When the electronic device 101 completes the selection of an image file as shown in areas 701, 702, 703, and 704 of FIG. 7A, the display 160 can display the selected image files indicated by bold outlines as shown in FIG. 7B and also various icons 705 for editing an image file.

When a select signal for an icon 706 among the icons 705 is inputted, the electronic device 101 can output at least one attribute information icon 707 for setting attribute information in the selected image file as shown in FIG. 7C. When an icon 708 for setting attribute information of “me” is selected from icons 707, the electronic device 101 can set attribute information in a selected image file as “me”. Then, the electronic device 101 can notify a user that the attribute information on the selected image file can be set as “me” by changing the color of the icon 708 corresponding to “me” among the icons 707 as shown in FIG. 7D.

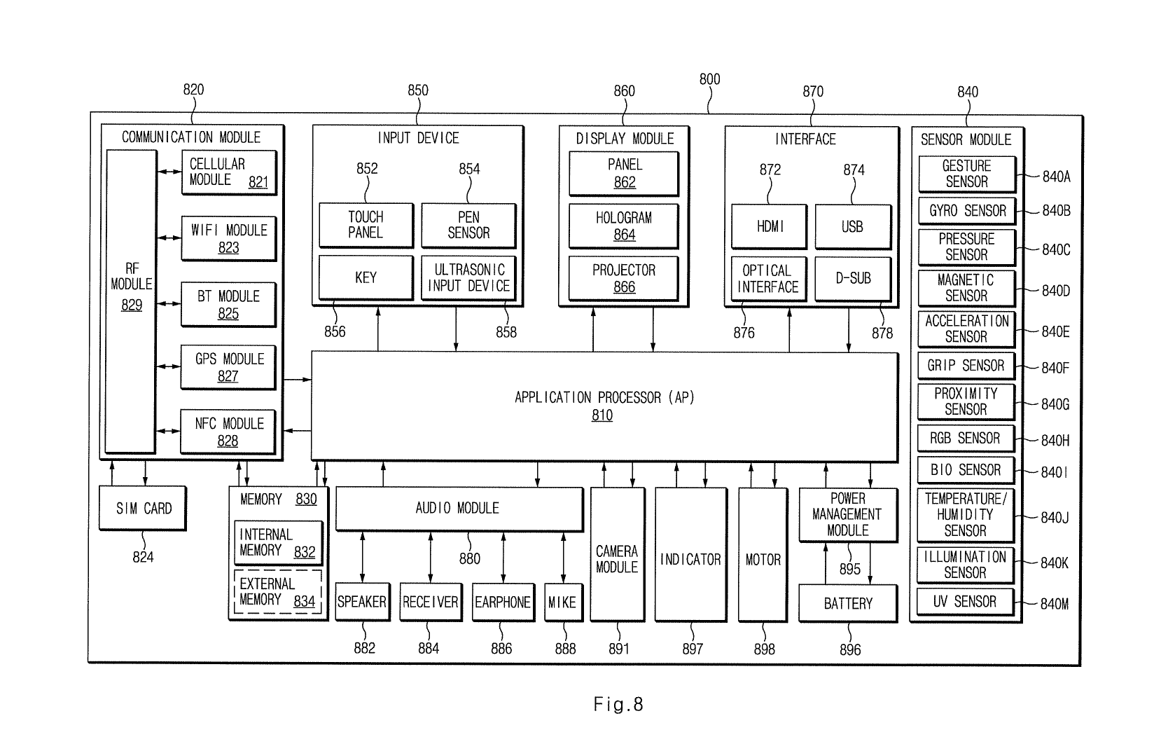

FIG. 8 is a block diagram illustrating an electronic device according this disclosure.

Referring to FIG. 8, the electronic device 800 can configure all or part of the image editing electronic device 101 shown in FIG. 1. The electronic device 800 can include at least one application processor (AP) 810, a communication module 820, a subscriber identification module (SIM) card 824, a memory 830, a sensor module 840, an input device 850, a display 860, an interface 870, an audio module 880, a camera module 891, a power management module 895, a battery 896, an indicator 897, and a motor 898.

The AP 810, for example, the processor 120 shown in FIG. 1, can control a plurality of hardware or software components connected to the AP 810 by executing an operating system or an application program and can perform various data processing and operations with multimedia data. The AP 810 can be implemented with a system on chip (SoC), for example. In an embodiment, the AP 810 can further include a graphic processing unit (GPU) (not shown). The processor 810 can receive an instruction from the above other components (for example, the communication module 820, the SIM card 824, the memory 830, the input device 850, the display module 860, and the camera module 891), interpret the received instruction, and perform operations and data processing in response to the interpreted instruction.

The AP 810, for example, the image processing module 180 shown in FIG. 1, can process at least part of information acquired from the above other components (for example, the communication module 820, the SIM card 824, the memory 830, the input device 850, the display module 860, and the camera module 891) and can then provide it to a user through various methods. The AP 810 can generate at least one attribute information by checking related information relating to a preview image acquired from the camera module 891. The AP 810 can acquire a preview screen as image content according to an image data acquire signal and can then generate image data by adding generated attribute information to image content. The AP 810 can store the generated image data according to attribute information.

The communication module 820 (for example, the communication interface 170 of FIG. 1) can perform data transmission through communication between other electronic devices connected to the electronic device 800 (for example, the electronic device 101) via a network. In an embodiment, the communication module 820 can include a cellular module 821, a Wifi module 823, a BT module 825, a GPS module 827, an NFC module 828, and a radio frequency (RF) module 829. The communication module 820 can receive at least one image content or image data from an external device through wired or wireless communication and can then provide it to the AP 820. At this point, image content can mean content having no set attribute information and image data can mean data having attribute information set in image content.

The cellular module 821 can provide voice calls, video calls, text services, or internet services through a communication network (for example, LTE, LTE-A, CDMA, WCDMA, UMTS, WiBro, or GSM). Additionally, the cellular module 821 can distinguish and authenticate an electronic device in a communication network by using a subscriber identification module (for example, the SIM card 824), for example. In an embodiment, the cellular module 821 can perform at least part of a function that the AP 810 provides. For example, the cellular module 821 can perform at least part of a multimedia control function.

In an embodiment, the cellular module 821 can further include a communication processor (CP). Additionally, the cellular module 821 can be implemented with SoC, for example. As shown in FIG. 8, components such as the cellular module 821 (for example, a CP), the power management module 295, or the memory 830 can be separated from the AP 810, but according to an embodiment of the present invention, the AP 810 can be implemented including some of the above-mentioned components (for example, the cellular module 821).

In an embodiment, the AP 810 or the cellular module 821 (for example, a CP) can load instructions or data, which are received from a nonvolatile memory or at least one of other components connected thereto, into a volatile memory and then can process them. Furthermore, the AP 810 or the cellular module 821 can store data received from or generated by at least one of other components in a nonvolatile memory.

Each of the Wifi module 823, the BT module 825, the GPS module 827, and the NFC module 828 can include a processor for processing data transmitted/received through a corresponding module. Although the cellular module 821, the Wifi module 823, the BT module 825, the GPS module 827, and the NFC module 828 are shown as separate blocks in FIG. 8, some (for example, at least two) of the cellular module 821, the Wifi module 823, the BT module 825, the GPS module 827, and the NFC module 828 can be included in one integrated chip (IC) or an IC package. For example, at least some (for example, a CP corresponding to the cellular module 821 and a Wifi processor corresponding to the Wifi module 823) of the cellular module 821, the Wifi module 823, the BT module 825, the GPS module 827, and the NFC module 828 can be implemented with one SoC.

The RF module 829 can be responsible for data transmission, for example, the transmission of an RF signal. The RF module 829 can include a transceiver, a power amp module (PAM), a frequency filter, or a low noise amplifier (LNA). Additionally, the RF module 829 can further include components for transmitting/receiving electromagnetic waves on a free space in a wireless communication, for example, conductors or conducting wires. Although the cellular module 821, the Wifi module 823, the BT module 825, the GPS module 827, and the NFC module 828 share one RF module 829 shown in FIG. 8, at least one of the cellular module 821, the Wifi module 823, the BT module 825, the GPS module 827, and the NFC module 828 can perform the transmission of an RF signal through an additional RF module.

The SIM card 824 can be a card including a subscriber identification module and can be inserted into a slot formed at a specific position of an electronic device. The SIM card 824 can include unique identification information (for example, an integrated circuit card identifier (ICCID)) or subscriber information (for example, an international mobile subscriber identity (IMSI)). The SIM card 824, for example, the memory 130 shown in FIG. 1, can store a feature point analysis algorithm for extracting and analyzing a at least one feature point from an object in a preview screen. The SIM card 824 can temporarily store a preview image obtained from the camera module 891. The SIM card 824 can store at least one image file. The SIM card 824 can store at least one attribute information, folder information, and information on a save path of image content.

The memory 830, for example, the memory 130 of FIG. 1, can include an internal memory 832 or an external memory 834. The internal memory 832 can include at least one of a volatile memory (for example, dynamic RAM (DRAM), static RAM (SRAM), synchronous dynamic RAM (SDRAM)) and a non-volatile memory (for example, one time programmable ROM (OTPROM), programmable ROM (PROM), erasable and programmable ROM (EPROM), electrically erasable and programmable ROM (EEPROM), mask ROM, flash ROM, NAND flash memory, and NOR flash memory). The memory 830, for example, the memory 130 shown in FIG. 1, can store a feature point analysis algorithm for extracting and analyzing a at least one feature point from an object in a preview screen. The memory 830 can temporarily store a preview image acquired from the camera module 891. The memory 830 can store at least one image file. The memory 830 can store at least one attribute information, folder information, and information on a save path of image content.

In an embodiment, the internal memory 832 can be a Solid State Drive (SSD). The external memory 834 can further include flash drive, for example, compact flash (CF), secure digital (SD), micro secure digital (Micro-SD), mini secure digital (Mini-SD), extreme digital (xD), or memorystick. The external memory 834 can be functionally connected to the electronic device 800 through various interfaces. In an embodiment, the electronic device 800 can further include a storage device (or a storage medium) such as a hard drive.

The sensor module 840 can measure physical quantities or detect an operating state of the electronic device 800, thereby converting the measured or detected information into electrical signals. The sensor module 840 can include at least one of a gesture sensor 840A, a gyro sensor 840B, a pressure sensor 840C, a magnetic sensor 840D, an acceleration sensor 840E, a grip sensor 840F, a proximity sensor 840G, a color sensor 84011 (for example, a red, green, blue (RGB) sensor), a bio sensor 8401, a temperature/humidity sensor 840J, an illumination sensor 840K, and a ultra violet (UV) sensor 840M. Additionally/alternately, the sensor module 840 can include an E-nose sensor, an electromyography (EMG) sensor, an electroencephalogram (EEG) sensor (not shown), an electrocardiogram (ECG) sensor, an infrared (IR) sensor, an iris sensor, or a fingerprint sensor. The sensor module 840 can further include a control circuit for controlling at least one sensor therein.

The input device 850, for example, the input/output interface 140 of FIG. 1, can include a touch panel 852, a (digital) pen sensor 854, a key 856, or an ultrasonic input device 858. The touch panel 852 (for example, the display 160) can recognize a touch input through at least one of capacitive, resistive, infrared, or ultrasonic methods, for example. Additionally, the touch panel 852 can further include a control circuit. In the case of the capacitive method, both direct touch and proximity recognition can be possible. The touch panel 852 can further include a tactile layer. In this case, the touch panel 852 can provide a tactile response to a user.

The (digital) pen sensor 854 can be implemented through a method similar or identical to that of receiving a user's touch input or an additional sheet for recognition. The key 856 (for example, the input/output interface 140) can include a physical button, an optical key, or a keypad. The ultrasonic input device 858, as a device checking data by detecting sound waves through a mike in the electronic device 800, can provide wireless recognition through an input tool generating ultrasonic signals. In an embodiment, the electronic device 800 can receive a user input from an external device (for example, a computer or a server) connected to the electronic device 200 through the communication module 820.

The display 860, for example, the display 160 of FIG. 1, can include a panel 862, a hologram 864, or a projector 866. The panel 862 can include a liquid-crystal display (LCD) or an active-matrix organic light-emitting diode (AM-OLED), for example. The panel 862 can be implemented to be flexible, transparent, or wearable, for example. The panel 862 and the touch panel 852 can be configured with one module. The hologram 864 can show three-dimensional images in the air by using the interference of light. The projector 866 can display an image by projecting light on a screen. The screen, for example, can be placed inside or outside the electronic device 800. According to an embodiment of the present invention, the display 860 can further include a control circuit for controlling the panel 862, the hologram 864, or the projector 866.

The interface 870 can include a high-definition multimedia interface (HDMI) 872, a universal serial bus (USB) 874, an optical interface 876, or a D-subminiature (sub) 878. Additionally/alternately, the interface 870 can include a mobile high-definition link (MHL) interface, a secure Digital (SD) card/multi-media card (MMC) interface, or an infrared data association (IrDA) standard interface.

The audio module 880 can convert sound and electrical signals in both directions. The audio module 880 can provide sound information inputted/outputted through a speaker 882, a receiver 884, an earphone 886, or a mike 888.

The camera module 891, for example, the camera 150 of FIG. 1, as a device for capturing an image and a video, can include at least one image sensor (for example, a front sensor or a rear sensor), a lens, an image signal processor (ISP), or a flash LED (for example, an LED or an xenon lamp). The camera module 891 can acquire a preview image according to a control of the AP 810. The camera module 891 can provide an image content acquired from a preview image to the AP 810.

The power management module 895 can manage the power of the electronic device 800. Although not shown in the drawings, the power management module 895 can include a power management integrated circuit (PMIC), a charger integrated circuit (IC), or a battery or fuel gauge, for example.

The PMIC can be built in an IC or SoC semiconductor, for example. A charging method can be classified as a wired method and a wireless method. The charger IC can charge a battery and can prevent overvoltage or overcurrent flow from a charger. In an embodiment, the charger IC can include a charger IC for at least one of a wired charging method and a wireless charging method. As the wireless charging method, for example, there can be a magnetic resonance method, a magnetic induction method, or an electromagnetic method. An additional circuit for wireless charging, for example, a circuit such as a coil loop, a resonant circuit, or a rectifier circuit, can be added.

A battery gauge can measure the remaining amount of the battery 896, or a voltage, current, or temperature of the battery 896 during charging. The battery 896 can store or generate electricity and can supply power to the electronic device 800 by using the stored or generated electricity. The battery 896, for example, can include a rechargeable battery or a solar battery.

The indicator 897 can display a specific state of the electronic device 800 or part thereof (for example, the AP 810), for example, a booting state, a message state, or a charging state. The motor 898 can convert electrical signals into mechanical vibration. Although not shown in the drawings, the electronic device 800 can include a processing device (for example, a GPU) for mobile TV support. The processing device for mobile TV support can process media data according to the standards such as digital multimedia broadcasting (DMB), digital video broadcasting (DVB), or media flow.

In an embodiment, an electronic device and method for acquiring image data can generate attribute information on a preview screen before obtaining image data and then can assign the attribute information to image data acquired from the preview screen and store it, so that efficient image data managements such as search, classification, and storage are possible.

In an embodiment, an electronic device and method for outputting a preview image to a displayed list according to an entry path to an image file list to check an image file, so that image data can be easily acquired from the image file list are disclosed herein.

In an embodiment, an electronic device and method for assigning attribute information set in at least one image data configuring an image file list to acquired image data and storing it in the image file list, so that efficient management of image data is possible.

Each of the above-mentioned components of the electronic device according to this disclosure can be configured with at least one component and the name of a corresponding component can vary according to the kind of an electronic device. The electronic device according to this disclosure can be configured including at least one of the above-mentioned components. Moreover, some components may be omitted or additional other components can be further included. Additionally, some of components of an electronic device according this disclosure can be configured as one entity, so that functions of previous corresponding components can be performed identically.

The term “module” used in this disclosure, for example, can mean a unit including a combination of at least one of hardware, software, and firmware. The term “module” and the tem′ “unit”, “logic”, “logical block”, “component”, or “circuit” can be interchangeably used. “module” can be a minimum unit or part of an integrally configured component. “module” can be a minimum unit performing at least one function or part thereof. “module” can be implemented mechanically or electronically. For example, “module” according to this disclosure can include at least one of an application-specific integrated circuit (ASIC) chip performing certain operations, field-programmable gate arrays (FPGAs), or a programmable-logic device.

According to various embodiments, at least part of a device (for example, modules or functions thereof) or a method (for example, operations) according to this disclosure, for example, as in a form of a programming module, can be implemented using an instruction stored in computer-readable storage media. When at least one processor executes an instruction, it can perform a function corresponding to the instruction. The computer-readable storage media can include a memory, for example. At least part of a programming module can be implemented (for example, executed) by a processor, for example. At least part of a programming module can include a module, a program, a routine, sets of instructions, or a process to perform at least one function, for example.

The computer-readable storage media can include Magnetic Media such as a hard disk, a floppy disk, and a magnetic tape, Optical Media such as Compact Disc Read Only Memory (CD-ROM) and Digital Versatile Disc (DVD), Magneto-Optical Media such as Floptical Disk, and a hardware device especially configured to store and perform a program instruction (for example, a programming module) such as Read Only Memory (ROM), Random Access Memory (RAM), and flash memory. Additionally, a program instruction can include high-level language code executable by a computer using an interpreter in addition to machine code created by a compiler. The hardware device can be configured to operate as at least one software module to perform an operation of this disclosure and vice versa.

A module of a programming module according to this disclosure can include at least one of the above-mentioned components or additional other components. Or, some programming modules can be omitted. Operations performed by a module, a programming module, or other components according to this disclosure can be executed through a sequential, parallel, repetitive or heuristic method. Additionally, some operations can be executed in a different order or can be omitted. Or, other operations can be added.

Although the present disclosure has been described with an exemplary embodiment, various changes and modifications can be suggested to one skilled in the art. It can be intended that the present disclosure encompass such changes and modifications as fall within the scope of the appended claims.

What is claimed is:

1. An electronic device comprising:
a camera configured to acquire a preview image and image content; and
an image processing module configured to generate at least one attribute information through information relating to the preview image and generate image data by adding the at least one attribute information to an image content acquired from the preview image.

2. The electronic device according to claim 1, wherein the image processing module is configured to check the information related to the preview image by checking an entry path to an image data acquisition mode for generating the image data.

3. The electronic device according to claim 2, wherein the image processing module is configured to extract an image file list by aligning at least one pre-stored image file on the basis of attribute information or folder information.

4. The electronic device according to claim 3, further comprising a display configured to output the preview image to the image file list as entering the image data acquisition mode from the image file list.

5. The electronic device according to claim 4, further comprising an input/output interface configured to generate a signal for performing at least one of a size adjustment and movement of the preview image, wherein the image processing module is configured to perform the at least one of the size adjustment and movement of the preview image according to the signal.

6. The electronic device according to claim 3, wherein the image processing module is configured to generate attribute information on the image content by using attribute information set in at least one image file configuring the image file list.

7. The electronic device according to claim 2, wherein as the electronic device enters the image data acquisition mode through at least one of shortcut keys, shortcuts, menus, and icons, the image processing module is configured to generate an attribute information set in an image file having a feature similar to a feature of the preview image by more than a critical value among at least one pre-stored image file by analyzing the preview image as attribute information on the image content.

8. The electronic device according to claim 7, further comprising an input/output interface configured to provide a select signal for at least one object in the preview image, wherein the image processing module is configured to check at least one feature point for an object corresponding to the select signal.

9. The electronic device according to claim 2, wherein the image processing module is configured to store the generated image data on the basis of the attribute information added to the generated image data or the entry path.

10. A method of acquiring image data, the method comprising:
entering an image data acquisition mode;
acquiring a preview image and checking information relating to the preview image;
generating at least one attribute information through the information relating to the preview image; and
generating image data by adding the at least one attribute information to an image content acquired from the preview image.

11. The method according to claim 10, wherein the checking of the information relating to the preview image comprises checking the information related to the preview image by checking an entry path to an image data acquisition mode for generating the image data.

12. The method according to claim 11, wherein the generating of the at least one attribute information further comprises:
extracting an image file list by aligning at least one pre-stored image file on the basis of attribute information and folder information.

13. The method according to claim 11, wherein the generating of the at least one attribute information further comprises, after entering the image data acquisition mode through at least one of shortcut keys, shortcuts, menus, and icons, generating attribute information set in an image file having a feature similar to a feature of the preview image by more than a critical value among at least one pre-stored image file by analyzing the preview image, as attribute information on the image content.

14. The method according to claim 13, wherein the generating of the at least one attribute information further comprises:
receiving a select signal on at least one object in the preview image.

15. The method according to claim 11, further comprising storing the generated image data on the basis of the at least one attribute information added to the generated image data or the entry path.

16. The method according to claim 12, wherein the generating of the at least one attribute information further comprises outputting the preview image to the image file list.

17. The method according to claim 16, wherein the generating of the at least one attribute information further comprises generating attribute information on the image content by using attribute information set in at least one image file configured the image file list.

18. The method according to claim 14, wherein the generating of the at least one attribute information further comprises checking at least one feature point for an object corresponding to the selected signal.

19. The method according to claim 18, wherein the generating of the at least one attribute information further comprises generating attribute information set in an image file having a feature point similar to the at least one feature point of the preview image by more than a critical value among the at least one pre-stored image file as attribute information on the image content.

20. The electronic device according to claim 1, wherein the electronic device comprises at least one of a smartphone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical equipment, a camera, or a wearable device.
